(19) United States
(12) Patent Application Publication
(10) Pub. No.: US 2026/0220643 A1
(43) Pub. Date: Jul. 30, 2026

(54) SYSTEMS AND TECHNIQUES FOR BLOCKCHAIN MONITORING

(71) Applicant: NAGRAVISION SARL, CHESEAUX-SUR-LAUSANNE (CH)

(72) Inventors: Nathan Hamiel, Jacksonville, FL (US); Vishruta Gowda Rudresh, Atlanta, GA (US)

(73) Assignee: NAGRAVISION SARL, CHESEAUX-SUR-LAUSANNE (CH)

(21) Appl. No.: 19/148,428

(22) PCT Filed: Feb. 6, 2024
(86) PCT No.: PCT/IB2024/051094

§ 371 Date: Jul. 16, 2025

Related U.S. Application Data
(60) Provisional application No. 63/444,485, filed on Feb. 9, 2023.

(51) Int. Cl. G06Q 20/40; G06Q 20/06; G06Q 20/36

(52) U.S. Cl. CPC G06Q 20/4016; G06Q 20/065; G06Q 20/36; G06Q 2220/00

(57) ABSTRACT

The present disclosure generally relates to monitoring a blockchain wallet. For example, aspects of the present disclosure include systems and techniques for monitoring a blockchain wallet. One example method for monitoring a blockchain wallet includes: generating a plurality of blockchain wallets associated with a blockchain service, the plurality of blockchain wallets comprising a user wallet and a plurality of monitored wallets; transferring funds to the plurality of monitored wallets; monitoring the plurality of blockchain wallets to identify unauthorized access of any of the plurality of blockchain wallets; in response to identifying unauthorized access of one of the plurality of monitored wallets, generating a notification that the one of the plurality of monitored wallets has been compromised; and outputting the notification.

### CROSS-REFERENCE TO RELATED APPLICATIONS

This application claims priority to U.S. Provisional Patent Application No. 63/444,485 filed Feb. 9, 2023, which is hereby incorporated by reference, in its entirety and for all purposes.

### FIELD

The present disclosure generally relates to blockchain monitoring. For example, aspects of the present disclosure include systems and techniques for monitoring a block chain service for an irregularity.

### BACKGROUND

A blockchain is a decentralised system that maintains an append-only journal of transaction data, typically involving virtual financial assets (crypto-currencies, fungible and non-fungible tokens). The data on a blockchain is stored as discrete blocks, each block containing a reference to the previous block as well as an arbitrary number of transactions, all of that verified and signed by validator nodes.

Some public blockchains attempt to achieve high transaction throughput by producing a new block every few seconds. The blockchain may support a cryptocurrency as well as multiple alternative tokens due to native support for assets defined by third parties. Some blockchains also support smart contracts, which are programs that the nodes on the chain can execute. A typical use case for a smart contract is a decentralized exchange, a platform where people can trade virtual financial assets without centralized intermediaries such as banks.

### SUMMARY

In some aspects, the techniques described herein relate to a method for monitoring a blockchain wallet, including: generating a plurality of blockchain wallets associated with a blockchain service, the plurality of blockchain wallets comprising a user wallet and a plurality of monitored wallets; transferring funds to the plurality of monitored wallets; monitoring the plurality of blockchain wallets to identify unauthorized access of any of the plurality of blockchain wallets; in response to identifying unauthorized access of one of the plurality of monitored wallets, generating a notification that the one of the plurality of monitored wallets has been compromised; and outputting the notification.

Certain aspects provide an apparatus for monitoring a blockchain wallet, including: a memory; and one or more processors coupled to the memory, the one or more processors being configured to: generate a plurality of blockchain wallets associated with a blockchain service, the plurality of blockchain wallets comprising a user wallet and a plurality of monitored wallets; transfer funds between the plurality of monitored wallets according to a transfer schedule; monitor the plurality of blockchain wallets to identify unauthorized access of any of the plurality of blockchain wallets; in response to identifying unauthorized access of one of the plurality of monitored wallets, generate a notification that the one of the plurality of monitored wallets has been compromised; and output the notification.

Certain aspects provide a non-transitory computer-readable medium having instructions stored thereon, that when executed by one or more processors, cause the one or more processors to: generate a plurality of blockchain wallets associated with a blockchain service, the plurality of blockchain wallets comprising a user wallet and a plurality of monitored wallets; transfer funds between the plurality of monitored wallets according to a transfer schedule; monitor the plurality of blockchain wallets to identify unauthorized access of any of the plurality of blockchain wallets; in response to identifying unauthorized access of one of the plurality of monitored wallets, generate a notification that the one of the plurality of monitored wallets has been compromised; and output the notification.

### BRIEF DESCRIPTION OF THE DRAWINGS

Illustrative embodiments of the present application are described in detail below with reference to the following drawing figures:

FIG. 1 illustrates an example computing device, in accordance with certain aspects of the present inventive concept.

FIG. 2 is a diagram illustrating an example monitoring system, in accordance with certain aspects of the present disclosure.

FIG. 3A illustrates example operations for blockchain monitoring, in accordance with certain aspects of the present disclosure.

FIG. 3B illustrates example operations for monitoring a blockchain wallet, in accordance with certain aspects of the present disclosure.

FIG. 4 illustrates an architecture of a computing system.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Losses and compromises (or unauthorized accesses) in the decentralized finance (Defi) space cause irreparable damage. There often is no early warning system alerting anyone when these compromises happen. In many cases, the compromise is not discovered until days after the attacker has already moved all the funds. When trying to track down where a compromise originated, many times, investigators are left trying to collect as much information as they can and do their best to triangulate wallets to a specific source application, which is a lengthy and time-consuming process costing valuable time while an attacker may be in the midst of an ongoing attack.

Certain aspects of the present disclosure are directed toward providing monitored wallets for identifying a compromise for a blockchain service. The monitored wallets act as a type of tripwire, allowing for a warning when a project or service has been compromised. This can alert users and project owners to a problem as soon as the issue is detected. Monitored wallets may be employed whenever the draining or transfer of funds of a wallet can be used as an indicator of compromise. Compromises and interactions may be collated into a centralized multi-party computation (MPC)-based system for forensic analysis to provide a holistic threat-intelligence platform.

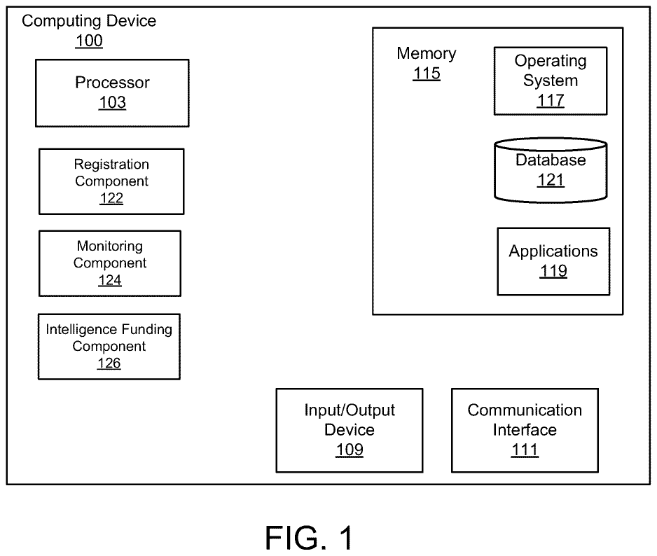

FIG. 1 illustrates an example computing device 100, in accordance with certain aspects of the present inventive concept. The computing device 100 can include a processor 103 for controlling overall operation of the computing device 100 and its associated components, including input/output device 109, communication interface 111, and/or memory 115. A data bus can interconnect processor(s) 103, memory 115, I/O device 109, and/or communication interface 111.

Input/output (I/O) device 109 can include a microphone, keypad, touch screen, and/or stylus through which a user of the computing device 100 can provide input and can also include one or more of a speaker for providing audio output and a video display device for providing textual, audiovisual, and/or graphical output. Software can be stored within memory 115 to provide instructions to processor 103 allowing computing device 100 to perform various actions. For example, memory 115 can store software used by the computing device 100, such as an operating system 117, application programs 119, and/or an associated internal database 121. The various hardware memory units in memory 115 can include volatile and nonvolatile, removable, and non-removable media implemented in any method or technology for storage of information such as computer-readable instructions, data structures, program modules or other data. Memory 115 can include one or more physical persistent memory devices and/or one or more non-persistent memory devices. Memory 115 can include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Communication interface 111 can include one or more transceivers, digital signal processors, and/or additional circuitry and software for communicating via any network, wired or wireless, using any protocol as described herein. Processor 103 can include a single central processing unit (CPU), which can be a single-core or multi-core processor (e.g., dual-core, quad-core, etc.), or can include multiple CPUs. Processor(s) 103 and associated components can allow the computing device 100 to execute a series of computer-readable instructions to perform some or all of the processes described herein. Although not shown in FIG. 1, various elements within memory 115 or other components in computing device 100, can include one or more caches, for example, CPU caches used by the processor 103, page caches used by the operating system 117, disk caches of a hard drive, and/or database caches used to cache content from database 121. For implementations including a CPU cache, the CPU cache can be used by one or more processors 103 to reduce memory latency and access time. A processor 103 can retrieve data from or write data to the CPU cache rather than reading/writing to memory 115, which can improve the speed of these operations. In some examples, a database cache can be created in which certain data from a database 121 is cached in a separate smaller database in a memory separate from the database, such as in RAM or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

In certain aspects of the present disclosure, the computing device 100 may include a secure database (e.g., database 121), a registration component 122, a monitoring component 124, an intelligent funding component 126. The computing device 100 may create wallets (e.g., off-chain) and register the wallets to a service. The service may be any blockchain service, such as a trading or betting service. The wallets may be funded in a way that looks as though a human owns the wallets. For example, depending on the service associated with the wallet, the wallet may be funded differently. A wallet associated with a trading service may experience many fund transfers, which may occur at particular times of the day. On the other hand, a wallet used as a liquidity pool for investments may not experience a high number of trades. In this case, the wallet may be provided an initial fund with little to no fund transfers after the initial funding of the wallet. In some aspects, each wallet may be only registered to a single service. In this manner, it is easy to identify where a compromise (or unauthorized access) associated with the wallet has occurred. If a wallet was compromised/is accessed without authorization, the monitoring system will raise an alert and create a notification.

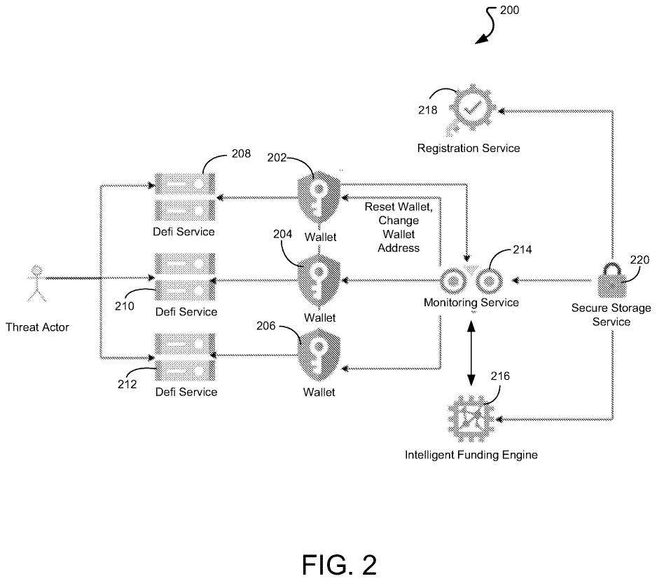

FIG. 2 illustrates an example monitoring system 200, in accordance with certain aspects of the present disclosure. In some aspects, the monitoring system 200 may include a registration component 218 (e.g., corresponding to the registration component 122). The registration component 218 may be a user entry point for the monitoring system 200. For example, a user may be provided a user interface to enter data for monitoring. For instance, the user may indicate a service to be monitored. In response, the monitoring system 200 may generate a wallet and register the wallet to the service as requested by the user for monitoring.

As shown, the monitoring system 200 includes a monitoring component 214 (e.g., corresponding to the monitoring component 124) that may be used to monitor generated wallets (e.g., wallets 202, 204, 206). The wallet may be accessed with a seed phrase associated with each wallet. The wallets 202, 204, 206 may be generated for services 208, 210, 212 (e.g., defi services), respectively. In some aspects, each wallet may be associated with a single service.

The monitoring component 214 may be communicably coupled to an intelligent funding engine 216 (e.g., intelligent funding component 126). The intelligent funding engine 216 may be used to fund the wallets 202, 204, 206 and transfer funds between (or within) wallets in an attempt to make it look to an attacker that an actual human being manages the wallets (e.g., as opposed to an automated system). The monitoring system 200 may track the transfer of funds accordingly to a schedule and identify when there has been a transfer of funds that is not in accordance with the schedule. If any transfer of funds is identified (e.g., other than the transfer of funds by the monitoring system), the monitoring system 200 may determine that a compromise (e.g., unauthorized access) to the wallet has occurred and send a notification of the compromise accordingly.

As described, the intelligent funding engine 216 generates the monitored wallets to appear as if to be owned by a human. The intelligent funding engine 216 automatically mints new tokens and funds the wallets at intervals to make the wallets appear as real as possible. It also interacts with a wallet to generate transactions to make the wallets appear as legit as possible. The transactions and funding of the wallets may depend on the type of service registered. As an example, if the wallet is for investing in liquidity tokens, it would be unlikely that funds would be moved around since the goal for the wallet is to keep the funds vested.

The monitoring system 200 includes a secure storage system 220 that holds the data relevant to the attack performed by the threat actor or wallet. The secure storage may be an MPC-based storage system to protect the integrity of the collected forensic data and store sensitive data such as private keys and seed phrases for wallets. For example, the MPC-based storage system may be accessed using a set of partial keys. For instance, multiple partial keys (e.g., associated with a key) may be generated for accessing the storage system. In some cases, only a subset of the partial keys may be necessary for accessing the storage system. The data stored by the secure storage system 200 may include forensic data about the attack. Forensic and other investigation teams may use this data to prepare meaningful and holistic threat/forensic reports quickly and efficiently.

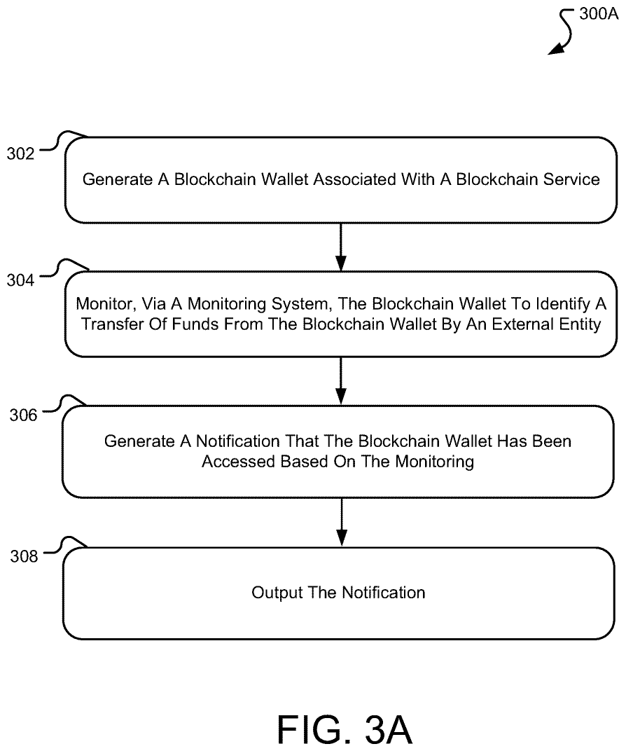

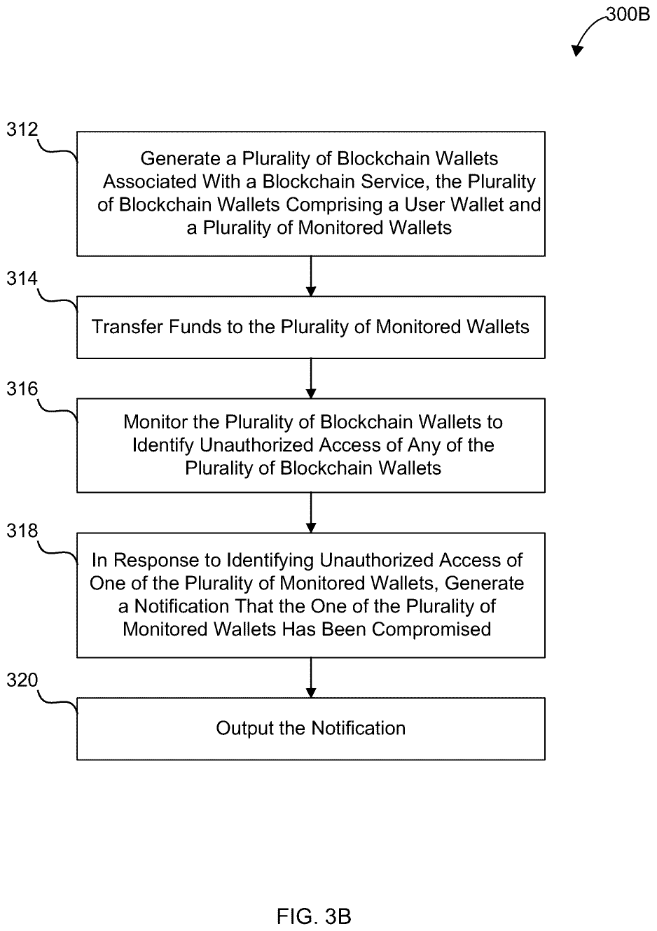

FIG. 3A illustrates example operations 300A for wallet monitoring, in accordance with certain aspects of the present disclosure. The operations 300A may be performed, for example, by a monitoring system, such as the monitoring system 200.

At block 302, the monitoring system generates a blockchain wallet associated with a blockchain service. For example, the monitoring system may receive (e.g., via a registration component 218) an indication of a service to be monitored. The blockchain wallet may be generated based on the indication of the service.

The blockchain wallet may be part of a group of wallets. The monitoring system may transfer funds between (or within) the group of wallets. The transfer of funds between (or within) the group of wallets may be based on a transfer schedule. The transfer schedule may be based on a service associated with the blockchain wallet. For example, the transfer schedule may be in accordance with a typical fund transfer by a human for the blockchain service.

At block 304, the monitoring system monitors the blockchain wallet to identify a transfer of funds from the blockchain wallet by an external entity. For example, the monitoring system may determine that the transfer of funds is not performed by the monitoring system. The transfer of funds may be identified as being by the external entity based on the determination.

At block 306, the monitoring system generates a notification that the blockchain wallet has been accessed or compromised (e.g., experienced an irregularity such as an attack by a hacker to steal funds) based on the monitoring. At block 308, the monitoring system outputs the notification. In some aspects, the monitoring system may store information associated with the transfer of funds by the external entity in a database. Access to the database may be provided based on receiving at least two partial keys. For example, the database may be secured using MPC.

FIG. 3B is a flow diagram illustrating a process 300B for monitoring a blockchain wallet, in accordance with aspects of the present disclosure. One or more operations of process 300B may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 300B. The one or more operations of process 300B may be implemented as software components that are executed and run on one or more processors.

At block 312, a computing device (and/or one or more components thereof) may generate a plurality of blockchain wallets associated with a blockchain service, the plurality of blockchain wallets comprising a user wallet and a plurality of monitored wallets. For example, monitoring service 214 of system 200 of FIG. 2 may generate wallets 202, 204, and/or 206.

In some aspects, the computing device (and/or one or more component thereof) may receive an indication of a service to be monitored. The plurality of blockchain wallets may be generated based on the indication of the service. For example, system 200 may receive an indication of a service and generate wallets 202, 204, and/or 206 based on the service.

At block 314, the computing device (and/or one or more components thereof) may transfer funds to the plurality of monitored wallets. For example, intelligent funding engine 216 of system 200 of FIG. 2 may fund wallets 202, 204, and/or 206.

In some aspects, the computing device (and/or one or more component thereof) may fund the plurality of monitored wallets based on the blockchain service. For example, intelligent funding engine 216 may fund wallets 202, 204, and/or 206 based on the blockchain service.

In some aspects, the computing device (and/or one or more component thereof) may transfer funds between the plurality of monitored wallets according to a transfer schedule. For example, intelligent funding engine 216 may transfer funds between wallets 202, 204, and/or 206.

In some aspects, the funds may be transferred between the plurality of monitored wallets by a funding engine. For example, intelligent funding engine 216 may transfer the funds between wallets 202, 204, and/or 206.

In some aspects, the transfer schedule may cause the transferring of funds to appear like active management of at least one of the plurality of monitored wallets. For example, the transfers of funds between wallets 202, 204, and/or 206 may appear like active management of at least one of wallets 202, 204, and/or 206.

In some aspects, the transfer schedule may be in accordance with a typical activity by a human for the blockchain service. For example, the transfers of funds between wallets 202, 204, and/or 206 may be in accordance with a typical activity by a human for the blockchain service.

In some aspects, the computing device (and/or one or more component thereof) may interact with the plurality of monitored wallets. For example, intelligent funding engine 216 may interact with wallets 202, 204, and/or 206.

In some aspects, the computing device (and/or one or more component thereof) may mint new tokens for the plurality of monitored wallets. For example, intelligent funding engine 216 may mint new tokens for wallets 202, 204, and/or 206.

At block 316, the computing device (and/or one or more components thereof) may monitor the plurality of blockchain wallets to identify unauthorized access of any of the plurality of blockchain wallets. For example, monitoring service 214 may monitor wallets 202, 204, and/or 206.

In some aspects, the plurality of blockchain wallets may be monitored by a monitoring system. In response to determining that a transfer of funds from the one of the plurality of monitored wallets is not according to the transfer schedule and is not performed by the monitoring system, the computing device (and/or one or more component thereof) may identify the transfer of funds as being performed by an external entity. For example, monitoring service 214 may monitor wallets 202, 204, and/or 206 and may determine that a transfer of funds not performed by monitoring service 214 and not according to the transfer schedule is performed by an external entity.

At block 318, the computing device (and/or one or more components thereof) may, in response to identifying unauthorized access of one of the plurality of monitored wallets, generate a notification that the one of the plurality of monitored wallets has been compromised. For example, in response to detecting unauthorized access of any of wallets 202, 204, and/or 206, monitoring service 214 may generate a notification indicative of the unauthorized access.

In some aspects, the computing device (and/or one or more component thereof) may store, in a database, information associated with the unauthorized access of the one of the plurality of monitored wallets that is not according to the transfer schedule. For example, in response to detecting unauthorized access of any of wallets 202, 204, and/or 206, monitoring service 214 may store a notification of the unauthorized access using a secure storage service 220.

In some aspects, access to the database may be provided based on receiving at least two partial keys. For example, access to secure storage service 220 may be provided based on receiving at least two partial keys.

In some aspects, the database may be secured using multi-party computation (MPC). For example, secure storage service 220 may be secured using MPC.

At block 320, the computing device (and/or one or more components thereof) may output the notification. For example, monitoring service 214 may output the notification.

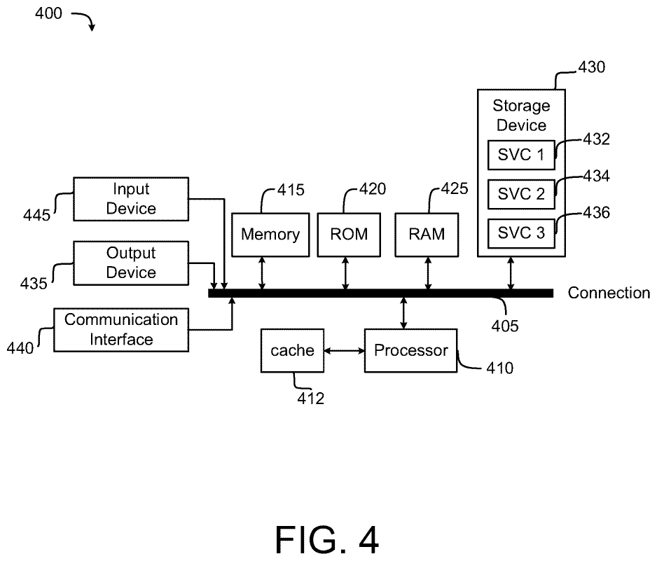

In some examples, as noted previously, the methods described herein (e.g., process 300A of FIG. 3A, process 300B of FIG. 3B, and/or other methods described herein) can be performed, in whole or in part, by a computing device or apparatus. In one example, one or more of the methods can be performed by system 200 of FIG. 2, or by another system or device. In another example, one or more of the methods (e.g., process 300A of FIG. 3A, process 300B of FIG. 3B, and/or other methods described herein) can be performed, in whole or in part, by the computing-device architecture 400 shown in FIG. 4. For instance, a computing device with the computing-device architecture 400 shown in FIG. 4 can include, or be included in, the components of the system 200 and can implement the operations of process 300A, process 300B, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 300A, process 300B, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 300A, process 300B, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 4 illustrates an architecture of a computing system 400 wherein the components of the system 400 are in electrical communication with each other using a connection 405, such as a bus. Exemplary system 400 includes a processing unit (CPU or processor) 410 and a system connection 405 that couples various system components including the system memory 415, such as read only memory (ROM) 420 and random-access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general-purpose processor and a hardware or software service, such as service 1 432, service 2 434, and service 3 436 stored in storage device 430, configured to control the processor 410 as well as a special-purpose processor where software instructions are incorporated into the actual processor design. The processor 410 may be a completely self-contained computing system, containing multiple cores or processors, a bus, memory controller, cache, etc. A multi-core processor may be symmetric or asymmetric.

To enable client interaction with the computing system 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a client to provide multiple types of input to communicate with the computing system 400. The communications interface 440 can generally govern and manage the client input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include services 432, 434, 436 for controlling the processor 410. Other hardware or software modules are contemplated. The storage device 430 can be connected to the system connection 405. In one aspect, a hardware module that performs a particular function can include the software component stored in a computer-readable medium in connection with the necessary hardware components, such as the processor 410, connection 405, output device 435, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

### EXAMPLE ASPECTS

Aspect 1. A method for wallet monitoring, comprising: generating a blockchain wallet associated with a blockchain service; monitoring, via a monitoring system, the blockchain wallet to identify a transfer of funds from the blockchain wallet by an external entity; generating a notification that the blockchain wallet has been accessed based on the monitoring; and outputting the notification.
Aspect 2. The method of aspect 1, wherein the blockchain wallet is part of a group of wallets, the method further comprising transferring funds within the group of wallets.
Aspect 3. The method of aspect 2, wherein the transfer of funds within the group of wallets is based on a transfer schedule.
Aspect 4. The method of aspect 3, wherein the transfer schedule is based on a service associated with the blockchain wallet.
Aspect 5. The method of any one of aspects 3-4, wherein the transfer schedule is in accordance with a typical fund transfer by a human for the blockchain service.
Aspect 6. The method of any one of aspects 1-5, further comprising storing information associated with the transfer of funds by the external entity in a database.
Aspect 7. The method of aspect 6, wherein access to the database is provided based on receiving at least two partial keys.
Aspect 8. The method of any one of aspects 6-7, wherein the database is secured using multi-party computation (MPC).
Aspect 9. The method of any one of aspects 1-8, further comprising receiving an indication of a service to be monitored, wherein the blockchain wallet is generated based on the indication of the service.
Aspect 10. The method of any one of aspects 1-9, further comprising determining that the transfer of funds is not performed by the monitoring system, wherein the transfer of funds is identified as being by the external entity based on the determination.
Aspect 11. An apparatus for wallet monitoring, comprising: a memory; and one or more processors coupled to the memory, the one or more processors being configured to: generate a blockchain wallet associated with a blockchain service; monitor, via a monitoring system, the blockchain wallet to identify a transfer of funds from the blockchain wallet by an external entity; generate a notification that the blockchain wallet has been accessed based on the monitoring; and output the notification.
Aspect 12. The apparatus of aspect 11, wherein the blockchain wallet is part of a group of wallets, the one or more processors being further configured to transfer funds within the group of wallets.
Aspect 13. The apparatus of aspect 12, wherein the transfer of funds within the group of wallets is based on a transfer schedule.
Aspect 14. The apparatus of aspect 13, wherein the transfer schedule is based on a service associated with the blockchain wallet.
Aspect 15. The apparatus of any one of aspects 13-14, wherein the transfer schedule is in accordance with a typical fund transfer by a human for the blockchain service.
Aspect 16. The apparatus of any one of aspects 11-15, wherein the one or more processors are further configured to store information associated with the transfer of funds by the external entity in a database.
Aspect 17. The apparatus of aspect 16, wherein access to the database is provided based on receiving at least two partial keys.
Aspect 18. The apparatus of any one of aspects 11-17, wherein the one or more processors are further configured to receive an indication of a service to be monitored, wherein the blockchain wallet is generated based on the indication of the service.
Aspect 19. The apparatus of any one of aspects 11-18, wherein the one or more processors are further configured to determine that the transfer of funds is not performed by the monitoring system, wherein the transfer of funds is identified as being by the external entity based on determination.
Aspect 20. A non-transitory computer-readable medium having instructions stored thereon, that when executed by one or more processors, cause the one or more processors to: generate a blockchain wallet associated with a blockchain service; monitor, via a monitoring system, the blockchain wallet to identify a transfer of funds from the blockchain wallet by an external entity; generate a notification that the blockchain wallet has been accessed based on the monitoring; and output the notification.
Aspect 21. A method for monitoring a blockchain wallet, the method comprising: generating a plurality of blockchain wallets associated with a blockchain service, the plurality of blockchain wallets comprising a user wallet and a plurality of monitored wallets; transferring funds to the plurality of monitored wallets; monitoring the plurality of blockchain wallets to identify unauthorized access of any of the plurality of blockchain wallets; in response to identifying unauthorized access of one of the plurality of monitored wallets, generating a notification that the one of the plurality of monitored wallets has been compromised; and outputting the notification.
Aspect 22. The method of aspect 21, further comprising transferring funds between the plurality of monitored wallets according to a transfer schedule.
Aspect 23. The method of aspect 22, wherein the transfer schedule causes the transferring of funds to appear like active management of at least one of the plurality of monitored wallets.
Aspect 24. The method of any one of aspects 22 or 23, wherein the transfer schedule is in accordance with a typical activity by a human for the blockchain service.
Aspect 25. The method of any one of aspects 22 to 24, further comprising storing, in a database, information associated with the unauthorized access of the one of the plurality of monitored wallets that is not according to the transfer schedule.
Aspect 26. The method of aspect 25, wherein access to the database is provided based on receiving at least two partial keys.
Aspect 27. The method of any one of aspects 25 or 26, wherein the database is secured using multi-party computation (MPC).
Aspect 28. The method of any one of aspects 22 to 27, wherein the plurality of blockchain wallets are monitored by a monitoring system, and further comprising in response to determining that a transfer of funds from the one of the plurality of monitored wallets is not according to the transfer schedule and is not performed by the monitoring system, identifying the transfer of funds as being performed by an external entity.
Aspect 29. The method of any one of aspects 22 to 28, wherein the funds are transferred between the plurality of monitored wallets by a funding engine.
Aspect 30. The method of any one of aspects 21 to 29, further comprising receiving an indication of a service to be monitored, wherein the plurality of blockchain wallets are generated based on the indication of the service.
Aspect 31. The method of any one of aspects 21 to 30, further comprising funding the plurality of monitored wallets based on the blockchain service.
Aspect 32. The method of any one of aspects 21 to 31, further comprising interacting with the plurality of monitored wallets.
Aspect 33. The method of any one of aspects 21 to 32, further comprising minting new tokens for the plurality of monitored wallets.
Aspect 34. An apparatus for monitoring a blockchain wallet, the apparatus comprising: at least one memory; and at least one processor coupled to the at least one memory and configured to: generate a plurality of blockchain wallets associated with a blockchain service, the plurality of blockchain wallets comprising a user wallet and a plurality of monitored wallets; transfer funds to the plurality of monitored wallets; monitor the plurality of blockchain wallets to identify unauthorized access of any of the plurality of blockchain wallets;

in response to identifying unauthorized access of one of the plurality of monitored wallets, generate a notification that the one of the plurality of monitored wallets has been compromised;

and output the notification.
Aspect 35. The apparatus of aspect 34, wherein the at least one processor is further configured to transfer funds between the plurality of monitored wallets according to a transfer schedule.
Aspect 36. The apparatus of aspect 35, wherein the transfer schedule causes the transferring of funds to appear like active management of at least one of the plurality of monitored wallets.
Aspect 37. The apparatus of any one of aspects 35 or 36, wherein the transfer schedule is in accordance with a typical activity by a human for the blockchain service.
Aspect 38. The apparatus of any one of aspects 35 to 37, wherein the funds are transferred between the plurality of monitored wallets by a funding engine running at the at least one processor.
Aspect 39. The apparatus of any one of aspects 34 to 38, further comprising funding the plurality of monitored wallets based on the blockchain service.
Aspect 40. A non-transitory computer-readable medium having stored thereon instructions that, when executed by one or more processors, cause the one or more processors to: generate a plurality of blockchain wallets associated with a blockchain service, the plurality of blockchain wallets comprising a user wallet and a plurality of monitored wallets; transfer funds between the plurality of monitored wallets according to a transfer schedule; monitor the plurality of blockchain wallets to identify unauthorized access of any of the plurality of blockchain wallets; in response to identifying unauthorized access of one of the plurality of monitored wallets, generate a notification that the one of the plurality of monitored wallets has been compromised; and output the notification.

What is claimed is:

1. A method for monitoring a blockchain wallet, the method comprising:
generating a plurality of blockchain wallets associated with a blockchain service, the plurality of blockchain wallets comprising a user wallet and a plurality of monitored wallets;
transferring funds to the plurality of monitored wallets;
monitoring the plurality of blockchain wallets to identify unauthorized access of any of the plurality of blockchain wallets;
in response to identifying unauthorized access of one of the plurality of monitored wallets, generating a notification that the one of the plurality of monitored wallets has been compromised; and
outputting the notification.

2. The method of claim 1, further comprising transferring funds between the plurality of monitored wallets according to a transfer schedule.

3. The method of claim 2, wherein the transfer schedule causes the transferring of funds to appear like active management of at least one of the plurality of monitored wallets.

4. The method of claim 2, wherein the transfer schedule is in accordance with a typical activity by a human for the blockchain service.

5. The method of claim 2, further comprising storing, in a database, information associated with the unauthorized access of the one of the plurality of monitored wallets that is not according to the transfer schedule.

6. The method of claim 5, wherein access to the database is provided based on receiving at least two partial keys.

7. The method of claim 5, wherein the database is secured using multi-party computation (MPC).

8. The method of claim 2, wherein the plurality of blockchain wallets are monitored by a monitoring system, and further comprising in response to determining that a transfer of funds from the one of the plurality of monitored wallets is not according to the transfer schedule and is not performed by the monitoring system, identifying the transfer of funds as being performed by an external entity.

9. The method of claim 2, wherein the funds are transferred between the plurality of monitored wallets by a funding engine.

10. The method of claim 1, further comprising receiving an indication of a service to be monitored, wherein the plurality of blockchain wallets are generated based on the indication of the service.

11. The method of claim 1, further comprising funding the plurality of monitored wallets based on the blockchain service.

12. The method of claim 1, further comprising interacting with the plurality of monitored wallets.

13. The method of claim 1, further comprising minting new tokens for the plurality of monitored wallets.

14. An apparatus for monitoring a blockchain wallet, the apparatus comprising:
at least one memory; and
at least one processor coupled to the at least one memory and configured to:
generate a plurality of blockchain wallets associated with a blockchain service, the plurality of blockchain wallets comprising a user wallet and a plurality of monitored wallets;
transfer funds to the plurality of monitored wallets;
monitor the plurality of blockchain wallets to identify unauthorized access of any of the plurality of blockchain wallets;
in response to identifying unauthorized access of one of the plurality of monitored wallets, generate a notification that the one of the plurality of monitored wallets has been compromised; and
output the notification.

15. The apparatus of claim 14, wherein the at least one processor is further configured to transfer funds between the plurality of monitored wallets according to a transfer schedule.

16. The apparatus of claim 15, wherein the transfer schedule causes the transferring of funds to appear like active management of at least one of the plurality of monitored wallets.

17. The apparatus of claim 15, wherein the transfer schedule is in accordance with a typical activity by a human for the blockchain service.

18. The apparatus of claim 15, wherein the funds are transferred between the plurality of monitored wallets by a funding engine running at the at least one processor.

19. The apparatus of claim 14, further comprising funding the plurality of monitored wallets based on the blockchain service.

20. A non-transitory computer-readable medium having stored thereon instructions that, when executed by one or more processors, cause the one or more processors to:
generate a plurality of blockchain wallets associated with a blockchain service, the plurality of blockchain wallets comprising a user wallet and a plurality of monitored wallets;
transfer funds between the plurality of monitored wallets according to a transfer schedule;
monitor the plurality of blockchain wallets to identify unauthorized access of any of the plurality of blockchain wallets;
in response to identifying unauthorized access of one of the plurality of monitored wallets, generate a notification that the one of the plurality of monitored wallets has been compromised; and
output the notification.
